(19) United States
(12) Patent Application Publication
(10) Pub. No.: US 2026/0080717 A1
(43) Pub. Date: Mar. 19, 2026

(54) DISTRIBUTED PROCESSING OF SIGNED NATURAL LANGUAGE INPUT(S) AND/OR OTHER GESTURES

(71) Applicant: GOOGLE LLC, Mountain View, CA (US)

(72) Inventors: Garrett Tanzer, Boston, MA (US); Manfred Georg, St. Louis, MO (US); David Uthus, Cupertino, CA (US); Thad Starner, Atlanta, GA (US); Sepehr Sam Sepah, Pleasanton, CA (US); William A. Truong, San Jose, CA (US); Sai Aditya Chitturu, Sunnyvale, CA (US)

(21) Appl. No.: 18/890,493

(22) Filed: Sep. 19, 2024

(51) Int. Cl. G06V 40/20; G06F 21/62; G06V 40/16; G10L 15/18

(52) U.S. Cl. CPC G06V 40/28; G06F 21/6254; G06V 40/161; G06V 40/171; G06V 40/172; G06V 40/174; G10L 15/18

(57) ABSTRACT

Implementations described herein relate to distributed processing of sign language input(s) and/or other gestures across multiple computing devices. For example, processor(s) of client device can receive user input that visually indicates a gesture and an identity of a user; generate, based on processing the user input, anonymized data that indicates the gesture of the user and that anonymizes the personal identity of the user; transmit a subset of the anonymized data to a computing device (e.g., a remote server or another client device); receive a natural language interpretation of the gesture of the user from the computing device; and perform an action based on the natural language interpretation of the gesture of the user. Notably, processor(s) of the computing device can generate the natural language interpretation of the gesture of the user and based on processing the subset of the anonymized data.

### BACKGROUND

Humans (also referred to herein as “users”) may communicate using various means, including sign language gestures, which may be inaudible and may represent at least one of a word, phrase, and/or sentence. Humans may also engage in human-to-computer dialogs with interactive software applications referred to as “chatbots,” “automated assistants,” “intelligent personal assistants,” etc. (referred to herein as “automated assistants”). For example, humans may communicate with an automated assistant in furtherance of causing an action to be performed, such as performing a search query.

While a client device of a user may process spoken natural language input from a human using local natural language processing (NLP), many client devices lack capabilities to locally process signed natural language input, such as American Sign Language (ASL). For example, a client device may accurately and efficiently process a spoken natural language input of “Assistant, search for places nearby to eat”, but may not accurately and efficiently process a signed natural language input of the same request. Accordingly, a client device may transmit data indicative of a signed natural language input to a remote system having access to computing resources that are capable of efficiently and accurately processing the signed natural language input.

However, a problem with transmitting data indicative of a signed natural language input to a remote system is that personally identifying characteristics of a user (providing the signed natural language input) may also be transmitted to the remote system, potentially creating data security concerns regarding user identity and the signed natural language requests. For example, a camera of a client device may capture a personally identifying characteristic of a user providing a signed natural language input, such as a face and/or body segment used to generate the signed natural language input. There may be no or few assurances of how personally identifying characteristics, including face and body segments of the user, may be used and/or secured on a remote system, thereby compromising security of user's data.

Another problem with transmitting data indicative of signed natural language input to a remote system is that transmitting such data may unnecessarily consume computational and/or networking resources. For example, transmitting data indicative of a signed natural language input may include transmitting image data or a stream of image data (e.g., video), which may include many more bytes of information compared to audio data or text data, and which may increase latency and reduce available network bandwidth. Additionally, image data (of signed natural language input) may be computationally expensive to process. As a consequence, automated assistant responses may temporally lag behind user input or even time-out, and device functionality in general may be slowed. These issues have negative impacts on consumption of network resources, consumption of computational resources, and introduce latency in human-to-computer dialogs.

### SUMMARY

Techniques are disclosed herein that enable more secure processing of signed natural language input and/or improved conservation of computational and/or network resources that are otherwise consumed in transmitting and processing signed natural language input.

Some implementations herein are directed to receiving, at a client device (e.g., having at least memory and processor(s)), signed natural language input that indicates a personal identity of a user, generating, at the client device, anonymized data that anonymizes the personal identify of the user and that indicates the signed natural language input, transmitting a subset of the anonymized data from the client device to a remote system, receiving, at the client device, natural language interpretation data that corresponds to the anonymized data and that identifies a natural language interpretation of the signed natural language input, and performing, at the client device, an action based on the natural language interpretation.

For example, a camera of a client device may capture both a signed natural language input provided by a user (e.g., the user bringing a hand up to their face to indicate eating/food) and a personally identifying characteristic of the user (e.g., a unique hand and/or face characteristic). In various implementations, the client device may determine to transmit data indicative of the signed natural language input to a remote server for processing. As some non-limiting examples, the client device may determine to transmit the data in response to determining a failure to locally process the signed natural language input; in response to determining the signed natural language input corresponds to a particular type of request (e.g., a search request that will be sent to the remote system to obtain content that is responsive to the search request); in response to determining a complexity metric and/or length metric of the signed natural language input satisfies a complexity threshold and/or length threshold; in response to determining a signal strength with the remote system satisfies a signal strength threshold; in response to determining computational resources available at the client device fail to satisfy a computational resource threshold (e.g., in terms of available memory at the client device and/or processing power available at the client device); in response to determining a location of the client device corresponds to a particular location or is within a threshold distance of the particular location; and/or based on other factors and/or considerations.

In various implementations, prior to transmitting the data indicative of the signed natural language input to the remote system, the client device may generate the anonymized data that indicates the signed natural language input and that anonymizes the personal identity of the user. Transmission of anonymized data (or a subset thereof), as opposed to transmission of non-anonymized data including personally identifying characteristics of a user, may address data security concerns and/or data security.

In various implementations, generating the anonymized data may be based on locally processing the signed natural language input using a machine learning model (for example, a media pipe holistic model). In some implementations, generating the anonymized data may be based on a point map that indicates a characteristic of the user while the signed natural language input is provided (e.g., a point mapping of a user's mouth, eyes, eyebrows, and/or hands, throughout a signed natural language input interaction, and in lieu of personally identifying data, such as a non-anonymized video). In additional or alternative implementations, generating the anonymized data may also include normalizing a point map to a default proportional template, which may have different proportions than a non-normalized point mapping of the user.

In various implementations, prior to transmitting the data indicative of the signed natural language input to the remote system and subsequent to generating the anonymized data locally at the client device, the client device may select the subset of the anonymized data to be transmitted to the remote system. For example, and as noted above, the anonymized data may include a point map that indicates a characteristic of the user while the signed natural language input is provided, such as a point mapping of a user's mouth, eyes, eyebrows, hands, torso, waist, legs, etc. In this example, the client device may select the anonymized data corresponding to the user's hands and optionally some other points in the point map (e.g., points for the user's mouth, eyes, eyebrows), and omit other points such as the waist and legs. Accordingly, the subset of the anonymized data is of a reduced size relative to the anonymized data in its entirety, thereby conserving network sources in transmitting the anonymized data to the remote system.

In some implementations, the client device may also compress data indicative of the signed natural language input (in whole and/or in part) before transmitting it to the remote system to reduce a transferrable size of the anonymized data, and correspondingly reduce computational and network strain associated with transmission and/or processing of large amounts of data. In some versions, the client device may transmit data in whole or in part by chunking (e.g., sequentially transmitting portions of data, rather than transmitting all portions of data simultaneously). In some implementations, the client device may transmit all portions of data simultaneously or continuously in a streaming manner.

In various implementations, subsequent to the data indicating the signed natural language input being transmitted to the remote system, the client device may receive and process natural language interpretation data that identifies a natural language interpretation of the signed natural language input. In some implementations, the client device may receive and/or process natural language interpretation data in chunks (e.g., receive and process first natural language interpretation data corresponding to a first portion of the signed natural language input and subsequently receive and process second natural language interpretation data corresponding to a second portion of the signed natural language input). In some implementations, the client device may receive and/or process natural language interpretation data simultaneously (e.g., receive and process first natural language interpretation data corresponding to a first portion of the signed natural language input and subsequently receive and process second natural language interpretation data corresponding to a second portion of the signed natural language input).

In some implementations, the client device may perform an action based on processing natural language interpretation data. For example, if natural language interpretation data indicates that a corresponding signed natural language input is associated with a request for an assistant to search for a peaceful place to picnic nearby, then the client device may cause a search corresponding to the request to be executed. Similarly, the client device may turn on a light if natural language interpretation data indicates that a corresponding natural language input is associated with a request to turn on a light.

By using various techniques disclosed herein, one or more technical advantages can be achieved. As one non-limiting example, the aforementioned problem of data security concerns and data security regarding user identity and transmission of signed natural language requests may be resolved using techniques disclosed herein, such as transmitting anonymized data (or a subset thereof) that is indicative of a signed natural language input and that anonymizes personally identifying characteristics of a user to remote system, and in lieu of transmitting the raw vision data that captures the user, an environment of the user, etc. As another non-limiting example, the aforementioned problem of a data transmission unnecessarily consuming computational and/or networking resources may be resolved using techniques disclosed herein, such as anonymizing data (e.g., including reducing unrefined image data to a point map representation), selecting a subset of the anonymized data to transmit to the remote system, and/or compressing data prior to transmission to a remote system.

The above description is provided as an overview of some implementations of the present disclosure. Further description of those implementations, and other implementations, are described in more detail below.

### DESCRIPTION OF THE DRAWINGS

FIG. 1 depicts an example environment in which implementations discussed herein may be implemented.

FIG. 2 depicts a process flow associated with implementations discussed herein from a client device perspective.

FIG. 3 depicts another process flow associated with implementations discussed herein from a remote system perspective.

FIG. 4 depicts a flow chart associated with implementations discussed herein from a client device perspective.

FIG. 5 depicts a flow chart associated with implementations discussed herein from a remote system perspective.

FIG. 6A depicts an environment in which signed natural language input is received by a client device.

FIG. 6B depicts data indicative of signed natural language input, a point map corresponding to the data, a normalization template, and a normalized point map.

FIG. 7 depicts anonymized data being transmitted to a remote system, and natural language interpretation data corresponding to the anonymized data being received from the remote system.

FIG. 8 depicts an example architecture of a computing device, in accordance with various implementations.

### DETAILED DESCRIPTION

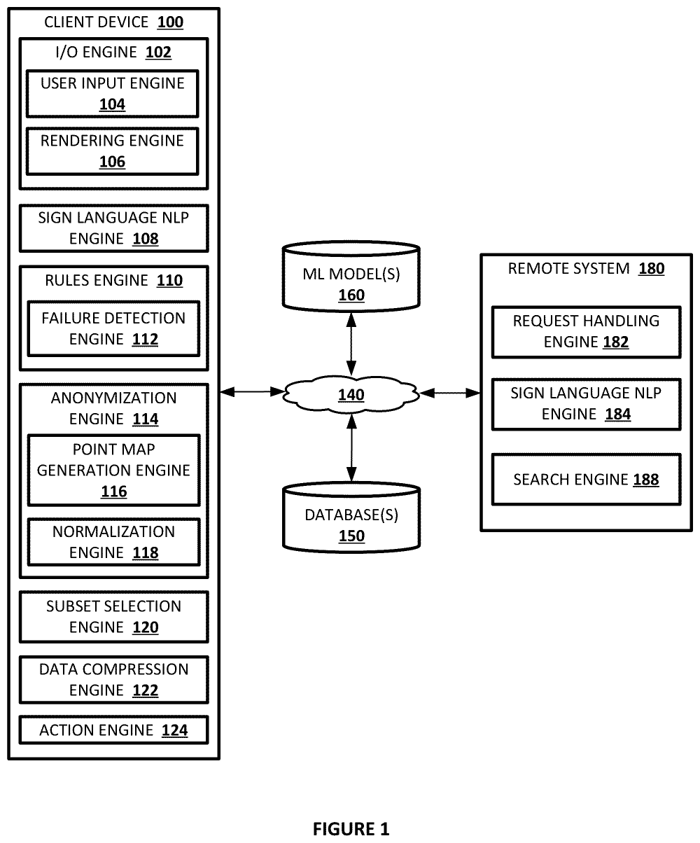

FIG. 1 depicts an example environment in which implementations discussed herein may be implemented. A client device 100 is illustrated in FIG. 1. Client device 100 may include one or more engines and/or be connected to one or more networks (e.g., network 140). Client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device, etc.). Additional and/or alternative client devices may be provided. Further, network 140 may include, for example, any combination of Wi-Fi®, Bluetooth®, or other local area networks (LANs); ethernet, the Internet, or other wide area networks (WANs); and/or other networks.

Client device 100 may include input/output (I/O) engine 102. I/O engine 102 may monitor, process, generate, and/or transmit one or more inputs and/or outputs. Inputs and/or outputs may be provided by and/or derived from a user and/or a computing device. I/O engine 102 may include user input engine 104 which may monitor, process, generate, and/or transmit one or more inputs that are provided by and/or derived from the user. Inputs may include spoken inputs captured in audio data generated by microphone(s) of client device 110, touch or typed inputs captured in generated by a touch sensitive display or other input component of client device 110, signed natural language inputs or gesture inputs captured in vision data generated by vision component(s) of client device 110, and/or other inputs described herein. I/O engine 102 may additionally include rendering engine 106, which may monitor, process, generate, render, and/or transmit one or more outputs provided by and/or derived from the computing device and/or the user. Outputs may include graphical outputs rendered by a display of client device 110, audible outputs rendered by speaker(s) of client device 110, haptic outputs rendered by component(s) of client device 110, and/or other outputs.

Client device 100 may include sign language natural language processing (NLP) engine 108. Sign language NLP engine 108 may monitor, process, generate, and/or transmit signed natural language input provided by and/or derived from one or more users and/or computing device, and using machine learning models 160 described herein. Sign language NLP engine 108 may also monitor, process, generate, and/or transmit non-signed natural language input provided by and/or derived from one or more users and/or computing devices (e.g., gestures that do not correspond to signed natural language input, background noise when signed natural language input is received, etc.). For example, sign language NLP engine 108 may process a signed-only natural language input asking where a good place to eat is. As another example, sign language NLP engine 108 may process a signed natural language input asking where a good place to eat is, that is also supplemented by an audible representation of this request. Accordingly, as an additional example, sign language NLP engine 108 may process a signed natural language input asking where a good place to eat is, that is also accompanied by background noise which may or may not be relevant to the signed natural language inquiry. Therefore, sign language NLP engine 108 may or may not be limited to processing only signed natural language input.

Client device 100 may include rules engine 110. Rules engine 110 may include one or more rules for client device 100. For example, rules engine 110 may include one or more rules regarding monitoring, processing, generating, and/or transmitting of data by client device 100. As an example, rules engine 110 may include a rule to transmit data in response to determining a failure to locally process signed natural language input. As another example, rules engine 110 may include a rule to transmit data in response to determining signed natural language input corresponds to a particular type of request (e.g., a search request, a request for a device to perform one or more actions, and/or other requests that require interaction with a remote system). As an additional example, rules engine 110 may include a rule to transmit data in response to determining a complexity and/or length of signed natural language input satisfies a metric. As a further example, rules engine 110 may include a rule to transmit data in response to determining a signal strength with a remote system that satisfies a threshold. As another example, rules engine 110 may include a rule to transmit data in response to determining a location of client device 100 corresponds to a particular location or is within a threshold distance of a particular location. Rules engine 110 may include one or more rules based on other factors and/or considerations. Rules engine 110 may include a failure detection engine 112 that may be specifically tasked with one or more rules for determining a failure to locally process signed natural language input.

Client device 100 may include anonymization engine 114. Anonymization engine 114 may generate anonymized data that indicates a signed natural language input and that anonymizes the personal identity of the user. Anonymization engine 114 may generate anonymized data based on processing unrefined data, such as image data, including video data. As discussed above, data security concerns associated with transmitting data that may personally identify a user may be mitigated and/or resolved by transmitting anonymized data. For example, video data or other vision data (generated at client device 100 or another computing device) may capture both signed natural language input and personally identifying characteristics of a user providing the signed natural language input. If client device 100 determines to send the video data to a remote server, a user may have data security concerns regarding the inclusion of personally identifying characteristics in the video data. However, if client device 100 anonymizes the video data using anonymization engine 114, and sends anonymized data in lieu of the video data, those data security concerns may be alleviated.

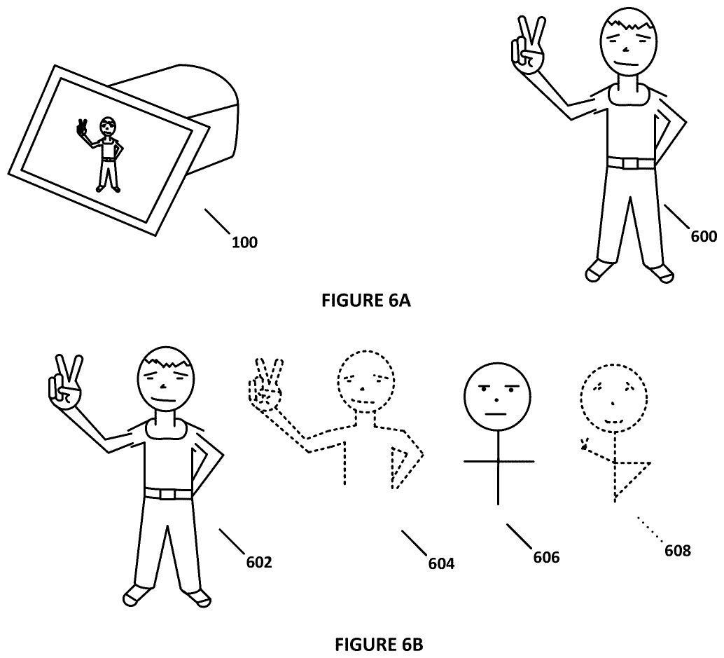

Anonymization engine 114 may include point map generation engine 116. As discussed above, anonymization engine 114 may generate anonymized data. The anonymized data that anonymization engine 114 may generate may be generated based on a point map that may be generated by point map generation engine 116. A point map that may be generated by point map generation engine 116 may indicate a characteristic of the user while the signed natural language input is provided (e.g., a point mapping of a user's mouth, eyes, eyebrows, and/or hands, throughout a signed natural language input interaction, and in lieu of personally identifying data, such as a non-anonymized video). An illustrative example of a point map, which may be generated by point map generation engine 116, may be found in FIG. 6B.

Anonymization engine 114 may additionally, or alternatively, include normalization engine 118. As discussed above, anonymization engine 114 may generate anonymized data. The anonymized data that anonymization engine 114 may generate may be generated based on a normalized template used by normalization engine 118. A normalized template may specify, for example, one or more default characteristics that otherwise personally identifying characteristics of a user may be normalized to align with. Characteristics may include, e.g., spacing, shapes, and/or colors of a user's body, including an eye, ear, mouth, nose, arm, and/or hand of a user. Normalization engine 118 may enhance, remove, shrink, enlarge, color saturate, and/or color leach personally identifying characteristics to align with a default normalized template. Normalizing personally identifying characteristics of the user may anonymize the features and thus anonymize a user.

Client device 100 may include subset selection engine 120. Subset selection engine 120 may be used by client device 100 to select a subset of data to be transmitted to a remote system. Subset selection engine 120 may be used prior to transmitting data indicative of the signed natural language input to a remote system. Subset selection engine 120 may be used subsequent to generating the anonymized data locally at client device 100. As discussed above, data, such as anonymized data, may indicate a characteristic of a user while signed natural language input is provided. As an example, anonymized data may include a point mapping of a user's mouth, eyes, eyebrows, hands, torso, waist, legs, etc. Subset selection engine 120 may select the anonymized data corresponding to the user's hands and optionally some other points in the point map (e.g., points for the user's mouth, eyes, eyebrows, etc. that may be anchor points of signed natural language input(s) where a user initiates and/or concludes the signed natural language inputs(s) and help facilitate understanding of the signed natural language input(s)), and omit other points such as the waist and legs. As one non-limiting example, subset selection engine 120 may select the anonymized data corresponding to the user's hands and/or mouth because those may be more dynamic points of the user and may therefore facilitate an improved understanding of the signed natural language input(s). By contrast, a user's waist and/or legs may be less dynamic and may not facilitate an improved understanding (or at least as great of an improved understanding as the user's hands and mouth) of the signed natural language input(s). The subset of data may have a reduced size relative to the full set of data, thereby conserving network sources by transmitting less data over a network to the remote system.

Client device 100 may include a data compression engine 122. Data compression engine 122 may compress data indicative of the signed natural language input (in whole and/or in part). Data compression engine 122 may compress data before transmitting it to a remote system. Compression of data by data compression engine 122 may reduce a size of data relative to a non-compressed size of data. Correspondingly, compression of data may further reduce computational and network strain associated with transmission and processing of large amounts of data, such as image data and/or other forms of vision data.

Client device 100 may include an action engine 124. Action engine 124 may cause one or more actions to be performed by client device 100 and/or another computing device. Action engine 124 may cause an action to occur based on processing natural language interpretation data. For example, if natural language interpretation data indicates that a corresponding signed natural language input is associated with a request to search for a peaceful place to picnic nearby, then action engine 124 may cause a search corresponding to the request to be executed. Similarly, the action engine 124 may cause a light to be turned on if natural language interpretation data indicates that a corresponding natural language input is associated with a request to turn on a light.

Network 140 may connect client device 100 with other components that are also connected to network 140. Other components may be connected via network 140 and may or may not be directly connected to client device 100. Other components may include database(s) 150, machine learning model(s) 160, and remote system 180. Components included in network 140 (including client device 100) may be constantly or periodically connected to network 140. Data transmitted over network 140 may be temporarily stored. For example, client device 100 may temporarily connect to network 140, transmit data over network 140, and disconnect from network 140, and the transmitted data may be temporarily stored (e.g., by instruction from client device 100 or by instruction from one or more other components connected to network 140). Adding to this example, subsequent to client device 100 transmitting data and disconnecting from network 140, remote system 180 may connect to network 140, and the temporarily stored data may be transmitted to remote system 180. Some components connected to network 140 may only be accessible by an exclusive subset of other components on network 140. For example, machine learning models 160, while on network 140, may only be accessible by remote system 180 and may not be accessible by client device 100, despite both remote system 180 and client device 100 both being on network 140. Additionally, or alternatively, an instance of the machine learning models 160 may be stored locally in memory of client device 110.

Network 140 may be connected to one or more databases 150. Database(s) 150 may include a signed natural language database. For example, signed natural language database may include signed natural language interpretations for one or more signed natural language inputs. Signed natural language may vary by region, dialect, institutions, etc., and a signed natural language database may include a compilation of the varying signed natural language inputs. Database(s) 150 may also include a remote system database, which may identify various remote systems and respective capabilities, and which may be used to identify an appropriate remote system to which client device 100 may transmit signed natural language input. For example, it may be determined that remote system 180 is the most capable remote system of a plurality of available remote systems, based on one or more criteria, such as bandwidth, remote system activity, remote system hardware and software, etc. Database(s) 150 may also include search engines, which may be used, for example, to perform a search action based on a signed natural language input.

Network 140 may provide access to one or more machine learning models 160. Machine learning models 160 may include a signed natural language input model that is trained to process signed natural language input. For example, a signed natural language input model may be trained based on signed natural language input. Machine learning models 160 may include machine learning models that are connected to databases 150 via network 140. Machine learning models 160 may include models that are trained based on databases 150.

Remote system 180 (e.g., a high performance server or a cluster of high performance servers) may be connected to network 140 via which remote system 180 and client device 100 may interact. Remote system 180 may include a request handling engine 182. Request handing engine 182 may handle requests received by remote system 180. For example, request handling engine 182 may handle requests received from client device 100, such as a request to process data indicative of a signed natural language input. Request handling engine 182 may determine whether or not to handle a particular request. A determination of whether or not to handle a particular request may be based on one or more factors, such as bandwidth, available processing capabilities, time of day, clients currently being or expected to be served, client device location, data size, etc.

Remote system 180 may include sign language NLP engine 184. Sign language NLP engine 184 may process data indicative of signed natural language input (e.g., including anonymized data representative of a signed natural language input) received by remote system 180 and using machine learning models 160 described herein. Sign language NLP engine 184 may process data indicative of signed natural language input based on an instruction from request handling engine 182. Sign language NLP engine 184 may process data indicative of signed natural language input based on connection with database(s) 150 and/or machine learning model(s) 160. For example, in processing data indicative of signed natural language input, sign language NLP engine 184 may utilize database(s) 150 and/or machine learning model(s) 160 to generate output. Put another way, sign language NLP engine 184 may apply input (e.g., data indicative of signed natural language input) to machine learning model(s) 160 in furtherance of generating output. Sign language NLP engine 184 may also transmit data to and/or receive data from database(s) 150 in furtherance of generating output.

Remote system 180 may include search engine 188. Search engine 188 may perform one or more searches based on instruction from sign language NLP engine 184 and/or client device 110. For example, sign language NLP engine 184 may determine that it is efficient to request that search engine 188 search for data in database(s) 150 while sign language NLP engine 184 simultaneously processes data that has been received at remote system 180. Search engine 188 may also communicate with machine learning model(s) 160. For example, search engine 188 may communicate data with machine learning model(s) 160 to efficiently execute searches.

Notably, client device 110 and/or remote system 180 may include one or more memories for storage of data and software applications, one or more processors for accessing data and executing the software applications, and other components that facilitate communication over networks 140.

Although FIG. 1 is depicted as including client device 110, remote system 180, and respective engines for client device 110 and remote system 180, it should be understood that is for the sake of example to illustrate various techniques contemplated herein and is not meant to be limiting. For example, one or more additional client devices can also be connected over network 140 to form an ecosystem of devices. Further, one or more engines of client device 110 can be added, combined, or omitted. Moreover, one or more engines of remote system 180 can be added, combined, or omitted.

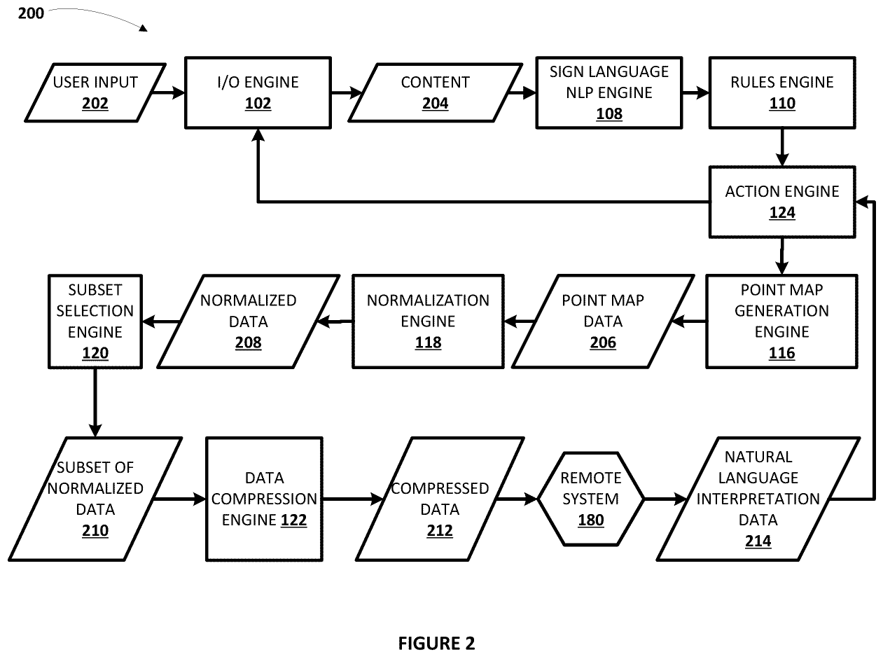

FIG. 2 depicts a process flow associated with implementations discussed herein from a client device perspective, such as from the perspective of client device 100 discussed above relative to FIG. 1. At block 202 user input is received by client device 100. User input may include visual, audible, and/or haptic input. User input may be identified by client device 100 or another device. For example, client device 100 may include a camera, microphone, and/or haptic sensor and may identify user input, or may be in communication with another device (such as a third party device) that may be capable of identifying user input but not processing the user input.

I/O engine 102 (discussed previously, in FIG. 1) may receive and/or process user input from block 202. As discussed previously, I/O engine 102 may manage input and output of data of client device 100. User input from block 202 is included in the umbrella of inputs that I/O engine 102 may manage. I/O engine 102 may process the user input and may identify and/or generate output such as content of block 204.

At block 204, I/O engine 102 identifies content. I/O engine 102 may identify content that is included in the user input of block 202. As another example, I/O engine 102 may identify content that is generated based on user input of block 202. Content may or may not differ from user input received in block 202. For example, user input received in block 202 may include one or more features that are not necessary for efficient and/or accurate processing of the user input. Put another way, if the user input is signed natural language input, then processing of audible background noise may be unnecessary, and the audible background noise may not be included in content of block 204. Further, processing of audible input along with the signed natural language input may cause inefficiencies and/or inaccuracies in processing the signed natural language input. For example, a user may be providing a signed natural language input to search for a place to eat and background audio input may include a passerby asking what time it is, resulting in a separate audio input inquiry and a separate signed natural language input inquiry. In contrast, content (e.g. identified in block 204) may only include features of the user input that are identified (e.g., by the I/O engine 102) as necessary for efficient and/or accurate processing. For example, content may include only visual signed natural language input and may not include audible background input, even if both visual signed natural language input and audible background input were included in the user input. It is also possible to separate audio input from the user from non-user audio (e.g., using speaker embeddings and/or cancellation techniques), so that content includes both signed natural language content from the user and audio from the user. It is also possible that only visual signed natural language input may be provided as user input in block 202, and content of block 204 may include the whole of the user input received in block 202 (e.g., sometimes the user input in block 202 and the content in block 204 may be the same).

In some implementations, sign language NLP engine 108 may attempt to process content of block 204. In some instances, sign language NLP engine 108 may successfully process content of block 204. In other instances, sign language NLP engine 108 may fail to process content of block 204. As discussed above, content of block 204 may include signed natural language input that is included in the content of block 204, and sign language NLP engine 108 may process the signed natural language input. Sign language NLP engine 108 may identify that processing of content from block 204 was successful. For example, sign language NLP engine 108 may successfully identify a natural language understanding corresponding to content from block 204, and may provide an indication of the natural language understanding corresponding to the content. Sign language NLP engine 108 may identify that processing content from block 204 was unsuccessful. For example, sign language NLP engine 108 may unsuccessfully identify a natural language understanding of content from block 204, and may provide an indication of a lack of natural language understanding of the content. An identification that sign language NLP engine 108 succeeded and/or failed to process content from block 204 may be used in subsequent blocks depicted in process 200.

In these implementations, rules engine 110 may receive an identification that sign language NLP engine 108 was successful and/or unsuccessful in processing content from block 204. Rules engine 110 may have a first rule responsive to an identification that sign language NLP engine 108 was successful in processing content from block 204, and/or may have a second rule responsive to an identification that sign language NLP engine 108 was unsuccessful in processing content from block 204. As discussed above, it is possible for both the first rule and the second rule to be invoked if sign language NLP engine 108 was only partially successful at processing content from block 204. An identification of one or more rules that rules engine 110 identifies as responsive to the identification from sign language NLP engine 108 may be used in subsequent blocks depicted in process 200.

Further, in these implementations, action engine 124 may receive an identification of one or more rules (that rules engine 110 identifies as) responsive to the identification from sign language NLP engine 108. For example, rules engine 110 may transmit one or more rules to action engine 124. Action engine 124 may cause an action based on the identification of a rule. For example, a first rule may define that action engine 124 may cause an action instruction to be sent to I/O engine 102 if sign language NLP engine 108 is successful in processing content from block 204. As another example, a second rule may define that action engine 124 may cause an action instruction to be sent to point map generation engine 116 if sign language NLP engine 108 is unsuccessful in processing content from block 204. As discussed above, it is possible that one or more rules may be identified, and action engine 124 may cause one or more instructions to be sent to both I/O engine 102 and point map generation engine 116. An instruction to I/O engine 102 may identify one or more graphical, audible, and/or haptic outputs to provide at client device 100. The outputs may indicate a response to user input in block 202 and/or an anticipated delay in response. Instructions to point map generation engine 116 may identify that a point map representation of content in block 204 (e.g., image data of a user) is needed.

In some versions of these implementations, point map generation engine 116 may receive one or more instructions from action engine 124. The one or more instructions from action engine 124 may include an instruction to cause point map data (discussed in more detail, subsequently), that is based on content in block 204, to be generated. Point map generation engine 116 may select a subset of features identifiable from content in block 204. Point map generation engine 116 may cause point map data to be generated based only on the subset of features identifiable from content in block 204. For example, content in block 204 may indicate both basic characteristics and personally identifying characteristics of a user's body. Basic characteristics of a user's body (e.g., locations of a face, mouth, ears, and/or nose relative to a location of a hand) may be included in the subset of features. However, personally identifying characteristics of a user's body (colors, precise topography and/or geometry, etc.) may not be included in the subset of features. Accordingly, point map generation engine 116 may cause point map data to be generated based only on basic and/or non-personally identifying characteristics of a user's body.

In other implementations, content of block 204 may be provided directly to point map generation engine 116. For example, sign language NLP engine 108, rules engine 110, and/or action engine 124 may be omitted (and/or temporarily inactive). Based on sign language NLP engine 108, rules engine 110, and/or action engine 124 being omitted and/or temporarily inactive, content of block 204 may be provided directly to point map generation engine.

At block 206, point map data is identified by client device 100. For example, point map data may be identified based on point map data being generated by point map generation engine 116. Point map data may include a point map representation of content from block 204. As discussed above, a point map representation of content from block 204 may be based on only a subset of features of content from block 204. For example, a point map representation may be based only on non-personally identifying characteristics of a user's body that is indicated in content from block 204. Accordingly, generation and communication of point map data from block 206 may eliminate and/or mitigate data security concerns that may be associated with generation and communication of data that personally identifies a user.

Normalization engine 118 may receive point map data of block 206. Normalization engine 118 may normalize point map data of block 206 based on receipt of point map data of block 206. Normalization engine 118 may normalize point map data of block 206 by modifying topological and/or geometrical features of point map data of block 206. For example, point map data of block 206 may indicate an ovular-shaped (or triangular-shaped, rectangular-shaped, heart-shaped, etc.) characteristic of a user's face, and normalization engine 118 may normalize the ovular-shaped characteristic to more circular proportions. Normalizing topological and geometrical characteristics may further anonymize a user's identity, while still enabling identification of signed natural language input that was provided by the user in block 202 and indicated in content from block 204.

In block 208, normalized data is identified by client device 100. Normalized data may be identified by client device 100 based on point map data of block 206 being normalized by normalization engine 118. The normalized data in block 208 may indicate a normalized point map representation of content from block 204. For example, content from block 204 may indicate both personally identifying characteristics of a user and a signed natural language input provided by the user. Due to the gestured nature in which signed natural language input is conveyed (e.g., facial expression, hand positions, movements, etc.), it may not be possible to entirely separate all characteristics of a user from signed natural language input. However, normalized data in block 208 may indicate the signed natural language input provided by a user without indicating personally identifying characteristics of the user.

Subset selection engine 120 may receive normalized data of block 208. Content of block 204, and normalized data of block 208, may include a characteristic of a user that is not necessary for signed natural language input processing. For example, a user's foot or torso may not be necessary for signed natural language input processing, but a user's face and hand may be necessary for signed natural language input processing. Subset selection engine 120 may determine which characteristics of a user are necessary for signed natural language input processing and may generate a subset of data indicative of only those necessary characteristics. Subset selection engine 120 may determine which characteristics of a user are necessary based on client device 100 processing and/or consultation with one or more components connected to network 140, such as database(s) 150 (which may indicate probabilities of characteristics of a user being necessary for signed natural language input processing). For example, even if sign language NLP engine 108 fails to process content from block 204 (or more precisely, signed natural language input included in the content from block 204), client device 100 may still be successful in determining which features of the content from block 204 are necessary for processing signed natural language input. Accordingly, subset selection engine 120 may cause a subset of normalized data (discussed in more detail subsequently) to be generated.

At block 210, a subset of normalized data is identified by client device 100. As discussed above, a subset of normalized data may include only features of the normalized data from block 208 that are necessary for processing signed natural language input (e.g., anchor points for signed natural language input), and may omit other features of the normalized data from block 208 that are not necessary for processing signed natural language inputs.

In some implementations, data compression engine 122 may receive the subset of normalized data from block 210. Data compression engine 122 may cause the subset of normalized data to be compressed based on receipt of the subset of normalized data. Data compression engine 122 may cause the subset of normalized data to be compressed using various techniques, including transform coding, run-length coding, Huffman coding, and/or other suitable data compression techniques. Compression of the subset of normalized data may further anonymize personally identifying characteristics of a user based on coding and/or recoding of normalized data during various compression techniques. Compression of the subset of normalized data may also reduce consumption of computational resources used in processing and communicating normalized data, based on compressed data being of a reduced file size. Compression of the subset of normalized data may also reduce network latency and consumption of network resources, as transmitting compressed (e.g., reduced file size) data may be faster than transmitting non-compressed data. In other implementations, the data compression engine 122 may be omitted.

In block 212, compressed data is identified by client device 100. Compressed data may be of a smaller file size than non-compressed data. Additionally, or alternatively, compressed data may also be of less complexity than non-compressed data based on the compression techniques used to generate the compressed data. Notably, compressed data from block 212 may be sent to remote system 180. For instance, compressed data from block 212 may be sent to remote system 180 in lieu of other input, content, and/or data illustrated in process 200, including user input from block 202, content from block 204, point map data from block 206, normalized data from block 208, subset of normalized data from block 210, etc.

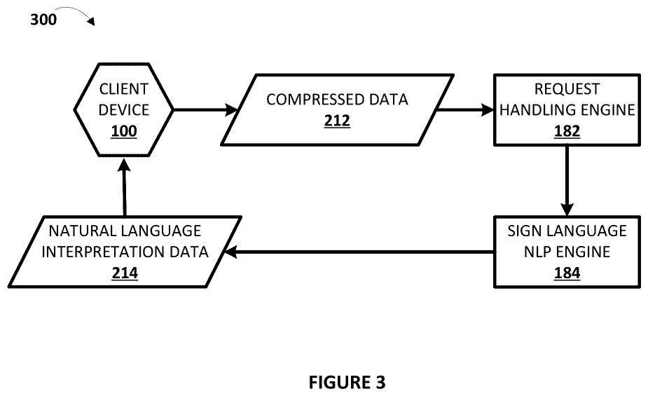

Remote system 180 may receive compressed data from block 212 (or a subset of normalized data from block 210 when the data compression engine 122 is omitted). Compressed data from block 212 may be transmitted from client device 100 (depicted in FIG. 1, and discussed previously). Client device 100 may transmit compressed data to remote system 180 over one or more networks 140. Remote system 180 may process compressed data from block 212. Techniques that are more specific to remote system 180 will be discussed subsequently, for example, in the detailed description of FIG. 3.

In block 214, natural language interpretation data from block 214 may be identified by client device 100. Natural language interpretation data may be received by client device 100 from remote system 180. Natural language interpretation data may indicate a natural language interpretation of features included in compressed data of block 212. For example, compressed data of block 212 may include features that indicate a signed natural language input that was indicated in user input from block 202, and natural language interpretation data from block 212 may indicate a natural language interpretation of that signed natural language input.

In various implementations, action engine 124, discussed previously, may receive the natural language interpretation data from block 214. Action engine 124 may generate an instruction for an action to be performed based on a natural language interpretation that may be indicated in the data. For example, the natural language interpretation data of block 214 may correspond with the user input of block 202 (specifically, a signed natural language input included in the user input) that included a request to search for a place to eat. Action engine 124 may generate an instruction to cause a search to be performed for a place to eat based on the natural language interpretation data of block 214.

I/O engine 102 may receive the instruction to cause a search to be performed for a place to eat. I/O engine 102 may generate an output that causes the search to be performed. Based on results of the search, I/O engine 102 may render an output at client device 100 that indicates a place to eat.

FIG. 3 depicts a process flow associated with implementations discussed herein from a remote system perspective, such as from the perspective of remote system 180 discussed above relative to FIG. 1. The process flow is based on process 300, which may include blocks 212 (or 210) and 214.

Remote system 180 may be in communication with client device 100. Remote system 180 and client device 100 may communicate over network(s) 140. At block 212, compressed data may be identified by remote system 180. Compressed data may be received by remote system 180 from client device 100. Compressed data may include and/or be accompanied by a request from client device 100 for remote system 180 to process the compressed data. Additionally, or alternatively, a subset of normalized data (e.g., that is not compressed) may be received by remote system 180 from client device 100.

Request handling engine 182 may determine what features are included in a request associated with compressed data (or a subset of normalized data) from block 212. Request handling engine 182 may determine whether to handle a request associated with compressed data from block 212. For example, request handling engine 182 may determine whether to accept or decline a request to cause processing compressed data from block 212. As another example, request handling engine 182 may determine how to handle a request associated with compressed data from block 212. As yet another example, request handling engine 182 may determine when to handle a request associated with compressed data from block 212. Further, request handling engine 182 may generate one or more instructions for sign language NLP engine 184 to process the compressed data from block 212 or a subset of normalized data from block 210.

Sign language NLP engine 184 may receive one or more instructions from request handling engine 182 to process the compressed data from block 212 and may process compressed data from block 212 based on the one or more instructions from request handling engine 182. Further, sign language NLP engine 184 may generate natural language interpretation data based on the compressed data from block 212. For example, compressed data may indicate one or more signed natural language inputs (e.g., hand and/or face gestures), and sign language NLP engine may process the one or more signed natural language inputs and generate natural language interpretation data that indicates natural language content (e.g., text) indicated by the one or more signed natural language inputs.

In block 214, the natural language interpretation data is generated by remote system 180. Remote system 180 may determine to transmit natural language interpretation data to client device 100.

Although process 200 of FIG. 2 and process 300 of FIG. 3 depict certain operations, it should be understood that is for the sake of example and is not meant to be limiting.

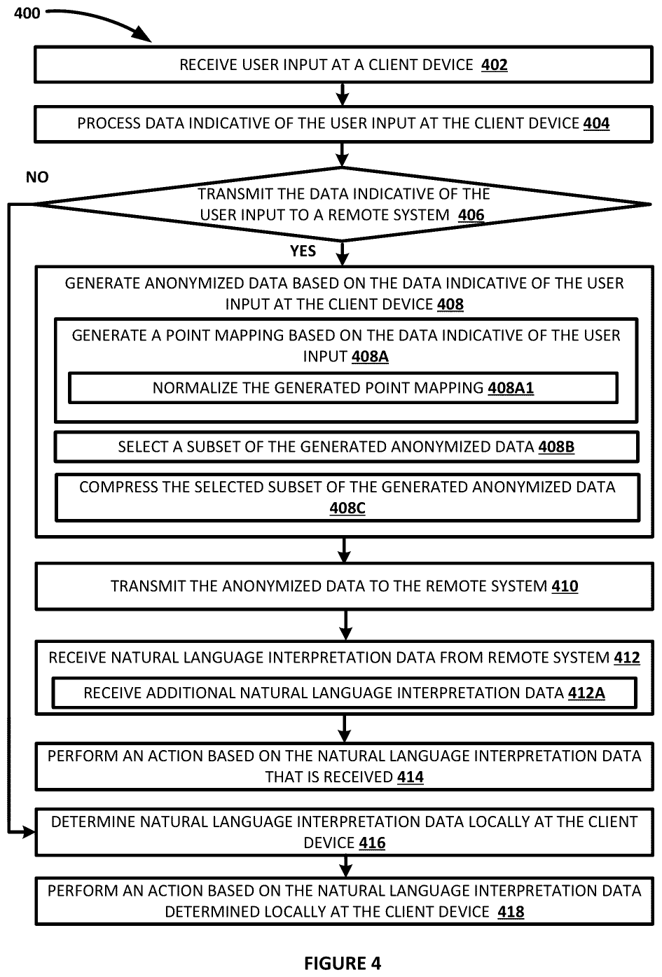

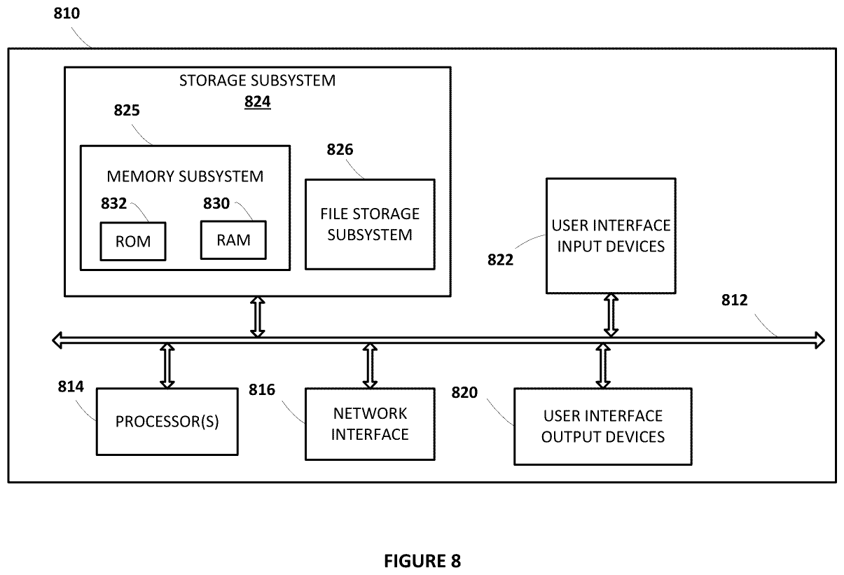

FIG. 4 depicts a flow chart 400 associated with implementations discussed herein from a client device perspective. For convenience, operations of flow chart 400 are described with reference to a client device that performs the operations, such as client device 100 of FIG. 1. The client device includes at least one processor, memory, and/or other component(s) of computing device(s) (e.g., client device 100 of FIG. 1, computing device 810 of FIG. 8, and/or other computing devices). Moreover, while operations of flow chart 400 are shown in a particular order, this is not meant to be limiting. One or more operations may be reordered, omitted, and/or added.

At block 402, a client device receives user input. The user input may visually indicate a gesture of a user and a personal identity of the user. For example, the gesture of the user may be a non-verbal communicative input. For instance, the gesture of the user may include a sign language communicative input, such as an American Sign Language (ASL) communicative input. Notably, the user input may include visual and/or audio characteristics. The user input may capture a first portion of the user and a second portion of the user. For example, the user input may capture a face of the user, and the user input may capture a torso of the user.

At block 404, the client device processes data indicative of the user input. The data may be processed using a machine learning model. Processing the data indicative of the user input may include identifying a face of the user in the user input, processing characteristics of the face, and generating an anonymized point mapping of the characteristics of the face based on processing the characteristics of the face. The characteristics of the face may include one or more of an eye, eyebrow, mount, cheek, nose, and ear. Processing the data indicative of the user input may include identifying a body segment of the user in the user input, processing characteristics of the body segment, and generating an anonymized point mapping of the characteristics of the body segment based on processing the characteristics of the body segment. The body segment may be above a waist of the user and may include one or more of a hand and/or a torso of the user. The machine learning model may be a point mapping model. The machine learning model may be a media pipe holistic model.

As discussed above, user input received at block 402 may capture a first portion of a user and a second portion of the user. For example, the first portion of the user may be a face of the user, and the second portion of the user may be a torso of the user. The first portion of the user may be processed at a first framerate and a second portion of the user may be processed at a second framerate. The client device may determine one or more framerates corresponding to one or more portions of the user. For example, the client device may determine one or more framerates corresponding to one or more portions of the user based on a rule (such as a rule from rules engine 110).

In some implementations, the client device may determine that a portion of the user identified as a face should be processed at a high framerate based on the face being one of the most expressive and/or dynamic portions of the user. Further, the client device may determine that a portion of the user identified as a torso should be processed at a lower framerate based on the torso being a less expressive and/or less dynamic portion of the user. Notably, the client device may identify one or more portions of a user based on pre-processing user input using one or more models (e.g., such as a MediaPipe Holistic model) to generate data that indicates the user input and/or portions of the user captured via the user input.

In these implementations, framerates at which portions of the user are processed may be throttled based on which and/or how many portions of a user are captured via user input. For example, if only one portion of the user is captured via user input, then that portion of the user may be processed at a higher framerate than it otherwise would be if other portions of the user were captured via the user input. For example, if both a face and a torso of the user are captured via user input, then the torso of the user may be processed at a low framerate, but if only a torso of the user is captured via user input, then the torso of the user may be processed at a high framerate.

At block 406, the client device determines whether data indicative of the user input should be transmitted to a remote server (e.g., remote system 180). If the client device determines that data indicative of the user input should not be transmitted to a remote server, then flow chart 400 may proceed to block 416, discussed subsequently. If the client device determines that data indicative of the user input should be transmitted to a remote server, then flow chart 400 may proceed to block 408. In some implementations, the client device can determine that data indicative of the user input should be transmitted to a remote server based on determining a failure to locally generate one or more of the natural language interpretations of the gesture of the user included in the user input or based on other conditions (e.g., described with respect to rules engine 110). In other implementations, the client device can determine that data indicative of the user data indicative of the user input should be transmitted to a remote server based on instructions provided by a developer associated with the client device and/or the remote server.

At block 408, the client device generates anonymized data based on the data indicative of the user input at the client device. The anonymized data may indicate the gesture of the user and may anonymize the personal identity of the user, and may be generated based on an anonymized point mapping of characteristics of the user's face. The client device may generate the anonymized data based on an anonymized point mapping of characteristics of a user's body segment. For example, at block 408A, the client device may generate a point mapping based on the data indicative of the user input. Further, at block 408A1, the client device may normalize the generated point mapping based on, for example, a default proportional template, where proportions of characteristics of the user's face may be different from proportions of the default template. Moreover, at block 408B, the client device may select a subset of the generated anonymized data. The subset of the generated anonymized data may include an anonymized point mapping of characteristics of a user's face. Furthermore, at block 408C, the client device may compress the selected subset of the generated anonymized data.

At block 410, the client device transmits the anonymized data to the remote server. The anonymized data transmitted to the remote server may be, for example, a subset of the anonymized data that is generated by the client device and based on the data indicative of the user input at the client device.

At block 412, the client device receives natural language interpretation data from the remote server. For example, the natural language interpretation data may identify a natural language interpretation of the gesture of the user. For instance, the natural language interpretation data may correspond to an interpretation of signed communicative input, such as an interpretation of ASL communicative input. In some of these instances, the natural language interpretation data may correspond to a textual interpretation of a signed communicative input, such as an English natural language interpretation of an ASL communicative input. At block 412A, the client device may receive additional natural language interpretation data from the remote server. Prior to block 414, and during an interaction that user input (which may include a gesture) from block 402 is received, further user input that visually identifies the personal identity of the user and that identifies another gesture of the user (that is in furtherance of the interaction) may be received, and additional anonymized data that indicates the other gesture of the user and anonymizes the personal identity of the user may be generated, an additional subset of the additional anonymized data may be transmitted to the remote system, additional natural language interpretation data that corresponds to the additional anonymized data, and that identifies a natural language interpretation of the additional gesture of the user, may be received at a client device.

At block 414, the client device performs an action based on the natural language interpretation data (and/or the additional natural language interpretation data) that is received. The action may be performed based on the natural language interpretation of the gesture (and/or the additional gesture) that is received from the remote server. For example, an action may be performed based on singular natural language interpretation data and/or a singular gesture of a user. As another example, an action may be performed based on a compilation of natural language interpretation data and/or multiple gestures of a user. An action may include performing a search query; audibly, visually, and/or haptically presenting an output to a user; modifying a state of a device (e.g., turning a smart device on, turning a smart device off, adjusting a color, brightness, volume, speed, vibration, etc., of a smart device); and/or other actions.

As discussed previously, at block 406, the client device may determine that data indicative of the user input should not be transmitted to a remote server. If the client device determines that data indicative of the user input should not be transmitted to a remote server, then flow chart 400 may proceed to block 416.

At block 416, the client device determines natural language interpretation data locally at the client device. The natural language interpretation data may be locally determined based on processing the user input using a machine learning model. The natural language interpretation data locally determined may or may not correspond to a sign language communicative input.

At block 418, an action is performed based on the natural language interpretation data locally determined at the client device. The action may be performed based on the natural language interpretation of the gesture (and/or the additional gesture) that is determined locally at the client device. For example, an action may be performed based on singular natural language interpretation data and/or a singular gesture of a user. As another example, an action may be performed based on a compilation of natural language interpretation data and/or multiple gestures of a user. An action may include performing a search query; audibly, visually, and/or haptically presenting an output to a user; modifying a state of a device (e.g., turning a smart device on, turning a smart device off, adjusting a color, brightness, volume, speed, vibration, etc., of a smart device); and/or other actions.

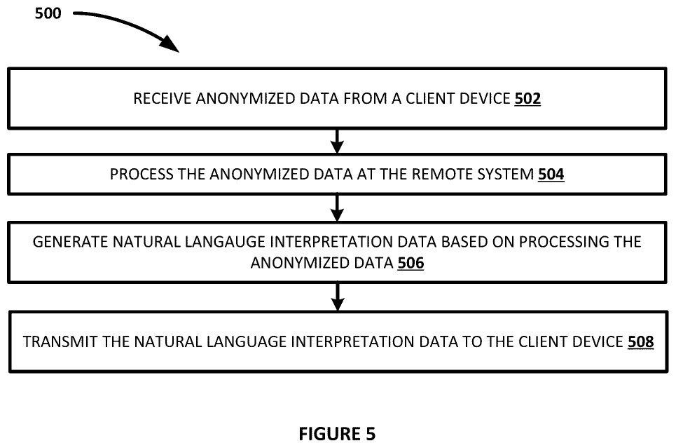

FIG. 5 depicts a flow chart associated with implementations discussed herein from a remote system perspective. For convenience, operations of flow chart 500 are described with reference to remote system that performs the operations, such as remote system 180 of FIG. 1. The remote system includes at least one processor, memory, and/or other component(s) of computing device(s) (e.g., remote system 180 of FIG. 1, computing device 810 of FIG. 8, and/or other computing devices). Moreover, while operations of flow chart 500 are shown in a particular order, this is not meant to be limiting. One or more operations may be reordered, omitted, and/or added.

At block 502, the remote system receives anonymized data from a client device. The anonymized data may be indicative of one or more of a hand gesture of a user and a facial gesture of the user. At block 504, the remote system processes anonymized data. At block 506, the remote system generates natural language interpretation data based on processing the anonymized data. At block 508, the remote system transmits natural language interpretation data to the client device.

FIG. 6A depicts an environment in which signed natural language input is received by a client device.

User 600 may provide one or more user inputs to client device 100. A user input may include a facial or body gesture, such as a smiling face with a hand having a thumb, ring finger, and pinky finger clinched and an index finger and middle finger extended (e.g., peace sign). This may be only one portion of user input provided in a user interaction. For example, user 600 may bring a hand to their mouth to indicate eating. The user 600 may provide a series of user inputs to client device 100, which when taken as a whole, equate to a request for client device 100 to search for a peaceful place to picnic.

FIG. 6B depicts data indicative of signed natural language input, a point map corresponding to the data, a normalization template, and a normalized point map.

Data indicative of a signed natural language input 602 may personally identify both a signed natural language input and personally identifying characteristics of the user 600.

A point map 604 corresponding to the data may anonymize user 600 by modifying and/or removing personally identifying characteristics of the user 600. For example, point map 604 may not include characteristics of a user 600 below the waist. As another example, point map 604 may not include a hairstyle of user 600. Further, point map 604 may not include identifying clothing articles of user 600. Additional or alternative anonymization operations may be performed to further anonymize the user 600.

A normalization template 606 may be used to normalize characteristics of user 600. Normalization template 606 may include default proportions, geometries, and/or topographies which data indicative of a signed natural language input 602, and/or point map 604, may be normalized to. For example, user 600 may have arms of a first size that may be normalized to arms of a second size based on normalization template 606. As another example, joints (e.g., elbows) that are not relevant to processing signed natural language input may not be represented in normalization template 606.

A normalized point map 608 may include characteristics indicated in point map 604 and/or normalization template 606. For example, normalized point map 608 may indicate normalized characteristics of point map 604. Put another way, point map 604 map indicate proportions, geometry, and/or topography of user 600, such as arm size and/or shape, torso size and/or shape, head size and/or shape, etc. However, normalized point map 608 may not indicate proportions, geometry, and/or topography of user 600. Normalized point map 608 may anonymize personally identifying characteristics of user 600 while maintaining representation of signed natural language input. For example, although normalized point map 608 does not indicate personally identifying characteristics of user 600, normalized point map 608 does indicate the gesture of a smiling face with a hand having a thumb, ring finger, and pinky finger clinched and an index finger and middle finger extended (e.g., peace sign), which may be indicative of user input, but not indicative of a personal identity of a user providing the input.

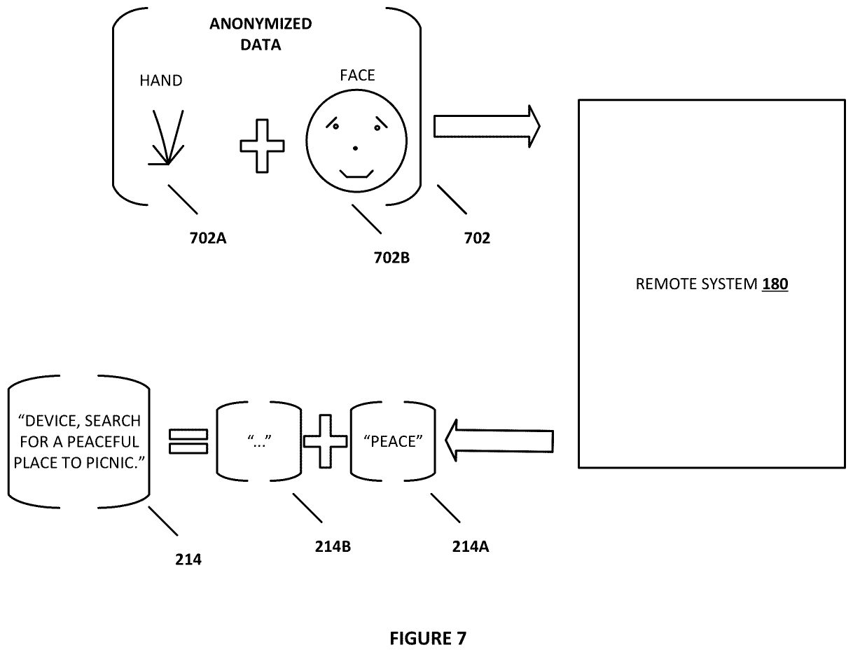

FIG. 7 depicts anonymized data being transmitted to a remote system, and natural language interpretation data corresponding to the anonymized data being received from the remote system.

Anonymized data 702 may include a hand 702A and/or a face 702B. The hand 702A and face 702B depicted in FIG. 7 is derived from the normalized point map 608 of FIG. 6. This anonymized data 702 may be sent (e.g., by client device 100) to remote system 180.

As discussed herein, remote system 180 may process the anonymized data 702 and transmit natural language interpretation data of block 214.

Natural language interpretation data of block 214 may include a plurality of portions, such as a first portion 214A and a second portion 214B. As discussed herein, data may be received, processed, generated, and/or transmitted in chunks. Accordingly, natural language interpretation data of block 214 may be a cumulation of the first portion 214A and the second portion 214B. For example, although user 600 in FIG. 6 is depicted as providing a peace sign as user input, that may not be the only signed natural language input provided in a given interaction. Therefore, natural language interpretation data of block 214 may reflect a cumulation of portions of natural language interpretation data, including 214A's “peace” interpretation data. Put another way, a cumulation of portions of natural language interpretation data, including 214A's “peace” interpretation data, may indicate a whole user input during an interaction of “Device, search for a peaceful place to picnic”.

Turning now to FIG. 8, a block diagram of an example computing device 810 that may optionally be utilized to perform one or more aspects of techniques described herein. In some implementations, one or more of a client device, remote system component(s), and/or other component(s) may comprise one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touchscreen incorporated into the display (e.g., a touch sensitive display), audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of the methods disclosed herein, as well as to implement various components depicted in other figures.

These software modules are generally executed by processor 814 alone or in combination with other processors. Memory 825 used in the storage subsystem 824 can include a number of memories including a main random-access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem 812 may use multiple busses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a client device is provided that includes a display, memory storing instructions, and one or more processors operable to execute the instructions, stored in the memory, to: receive, at the client device, user input that visually indicates a gesture of a user and a personal identity of the user; generate, based on processing the user input using a machine learning model, anonymized data that indicates the gesture of the user and that anonymizes the personal identity of the user; transmit a subset of the anonymized data to a computing device; receive, at the client device and from the computing device, natural language interpretation data that corresponds to the anonymized data, and that identifies a natural language interpretation of the gesture of the user; and perform an action based on the natural language interpretation of the gesture of the user.

These and other implementations of technology disclosed herein can optionally include one or more of the following features.

In some implementations, the user input may include both visual input and audio input, and the anonymized data that is transmitted to the computing device may only includes visual input.

In some implementations, the gesture of the user may be a non-verbal communicative input.

In some implementations, the instructions to process the user input using the machine learning model may include instructions to: identify a face, of the user, in the user input; process characteristics of the face; and generate, based on processing the characteristics of the face, an anonymized point mapping of the characteristics of the face. The anonymized data may be generated based on the anonymized point mapping of the characteristics of the face, and the subset of the anonymized data may include a subset of the anonymized point mapping of the characteristics of the face.

In some versions of those implementations, the characteristics of the face may include one or more of: an eye, eyebrow, mouth, cheek, nose, and ear.

In additional or alternative versions of those implementations, the instructions to process the user input using the machine learning model may include instructions to: normalize, using a default proportional template, the anonymized point mapping of the characteristics of the face. Proportions of the characteristics of the face may be different from proportions of the default proportional template, and the anonymized data may be generated based on normalizing the anonymized point mapping of the characteristics of the face.

In additional or alternative versions of those implementations, the instructions to process the user input using the machine learning model may include instructions to: identify body segments of the user, in addition to the face of the user, in the user input; process characteristics of the body segments of the user, in addition to processing characteristics of the face of the user; and generate, based on processing the characteristics of the body segments, an anonymized point mapping of the characteristics of the body segments. The anonymized data may be generated based on the anonymized point mapping of the characteristics of the body segments.

In some further versions of those implementations, the body segments may be above a waist of the user and include one or more of a hand of the user and a torso of the user.

In some implementations, the machine learning model may be a point mapping model.

In some versions of those implementations, the machine learning model may be a media pipe holistic model.

In some implementations, the gesture of the user may include an American Sign Language (ASL) communicative input.

In some versions of those implementations, the natural language interpretation data may correspond to an interpretation of the ASL communicative input.

In some implementations, the user input may capture a first portion of the user and a second portion of the user, and the instructions to process the user input using the machine learning model may include instructions to: process the first portion of the user at a first framerate; and process the second portion of the user at a second framerate.

In some implementations, the memory may further include instruction to, prior to executing an instruction to perform the action based on the natural language interpretation of the gesture of the user: receive, at the client device and during an interaction that the gesture is received, further user input that visually identifies the personal identity of the user and that identifies another gesture of the user that is in furtherance of the interaction; generate, based on processing the further user input using the machine learning model, additional anonymized data that indicates the other gesture of the user and anonymizes the personal identity of the user; transmit an additional subset of the additional anonymized data to the computing device; receive, at the client device and from the computing device, additional natural language interpretation data that corresponds to the additional anonymized data, and that identifies a natural language interpretation of the other gesture of the user; and determine, based on processing the natural language interpretation of the gesture of the user and the natural language interpretation of the other gesture of the user, the action to be performed.

In some implementations, the memory may further include instructions to, prior to executing an instruction to generate the anonymized data: determine a failure to locally generate, based on processing the user input using the machine learning model or another machine learning model locally at the client device, the natural language interpretation of the gesture of the user or another natural language interpretation of the gesture of the user. The instructions to generate the anonymized data may be executed in response to determining the failure to locally generate the natural language interpretation of the gesture of the user or the other natural language interpretation of the gesture of the user.

In some implementations, the natural language interpretation of the gesture of the user may indicate an English natural language interpretation of American Sign Language communicative input that is included in the user input.

In some implementations, the gesture of the user may be a request for a search query to be performed, and performing the action may include performing at least one of the search query or another search query associated with the search query.

In some implementations, a system is provided that includes memory storing instructions, and one or more processors operable to execute the instructions, stored in the memory, to: receive, from a client device, a subset of anonymized data that is indicative of a gesture of a user, and that is indicative of a device identifier associated with the subset of the anonymized data; generate, based on processing the subset of the anonymized data using a machine learning model, a natural language interpretation of the gesture of the user; and transmit, based on the device identifier associated with the subset of the anonymized data, the natural language interpretation to the client device or another client device.

These and other implementations of technology disclosed herein can optionally include one or more of the following features.

In some implementations, the data that is indicative of the gesture of the user may be indicative of one or more of a hand gesture of the user and a facial gesture of the user.

In addition, some implementations include systems having one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to execute any of the aforementioned instructions. Some implementations also include one or more non-transitory computer readable storage media storing computer instructions executable by one or more processors to perform any of the aforementioned instructions. Some implementations also include a computer program product including instructions executable by one or more processors to perform any of the aforementioned instructions. Some implementations also include a method implemented by one or more processors to perform any of the steps of the aforementioned instructions.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

We claim:

1. A client device comprising:
a display;
a memory storing instructions; and
one or more processors operable to execute the instructions, stored in the memory, to:
receive, at the client device, user input that visually indicates a gesture of a user and a personal identity of the user;
generate, based on processing the user input using a machine learning model, anonymized data that indicates the gesture of the user and that anonymizes the personal identity of the user;
transmit a subset of the anonymized data to a computing device;
receive, at the client device and from the computing device, natural language interpretation data that corresponds to the anonymized data, and that identifies a natural language interpretation of the gesture of the user; and
perform an action based on the natural language interpretation of the gesture of the user.

2. The client device of claim 1, wherein the user input includes both visual input and audio input, and the anonymized data that is transmitted to the computing device only includes visual input.

3. The client device of claim 1, wherein the gesture of the user is a non-verbal communicative input.

4. The client device of claim 1, wherein the instructions to process the user input using the machine learning model include instructions to:
identify a face, of the user, in the user input;
process characteristics of the face; and
generate, based on processing the characteristics of the face, an anonymized point mapping of the characteristics of the face,
wherein the anonymized data is generated based on the anonymized point mapping of the characteristics of the face, and
wherein the subset of the anonymized data includes a subset of the anonymized point mapping of the characteristics of the face.

5. The client device of claim 4, wherein the characteristics of the face include one or more of: an eye, eyebrow, mouth, cheek, nose, and ear.

6. The client device of claim 4, wherein the instructions to process the user input using the machine learning model include instructions to:
normalize, using a default proportional template, the anonymized point mapping of the characteristics of the face, wherein proportions of the characteristics of the face are different from proportions of the default proportional template, and wherein the anonymized data is generated based on normalizing the anonymized point mapping of the characteristics of the face.

7. The client device of claim 4, wherein the instructions to process the user input using the machine learning model include instructions to:
identify body segments of the user, in addition to the face of the user, in the user input;
process characteristics of the body segments of the user, in addition to processing characteristics of the face of the user; and
generate, based on processing the characteristics of the body segments, an anonymized point mapping of the characteristics of the body segments,
wherein the anonymized data is generated based on the anonymized point mapping of the characteristics of the body segments.

8. The client device of claim 7, wherein the body segments are above a waist of the user and include one or more of a hand of the user and a torso of the user.

9. The client device of claim 1, wherein the machine learning model is a point mapping model.

10. The client device of claim 9, wherein the machine learning model is a media pipe holistic model.

11. The client device of claim 1, wherein the gesture of the user includes an American Sign Language (ASL) communicative input.

12. The client device of claim 11, wherein the natural language interpretation data corresponds to an interpretation of the ASL communicative input.

13. The client device of claim 1, wherein the user input captures a first portion of the user and a second portion of the user, and wherein the instructions to process the user input using the machine learning model include instructions to:
process the first portion of the user at a first framerate; and
process the second portion of the user at a second framerate.

14. The client device of claim 1, wherein the memory further comprises instruction to, prior to executing an instruction to perform the action based on the natural language interpretation of the gesture of the user:
receive, at the client device and during an interaction that the gesture is received, further user input that visually identifies the personal identity of the user and that identifies another gesture of the user that is in furtherance of the interaction;
generate, based on processing the further user input using the machine learning model, additional anonymized data that indicates the other gesture of the user and anonymizes the personal identity of the user;
transmit an additional subset of the additional anonymized data to the computing device;
receive, at the client device and from the computing device, additional natural language interpretation data that corresponds to the additional anonymized data, and that identifies a natural language interpretation of the other gesture of the user; and
determine, based on processing the natural language interpretation of the gesture of the user and the natural language interpretation of the other gesture of the user, the action to be performed.

15. The client device of claim 1, wherein the memory further comprises instructions to, prior to executing an instruction to generate the anonymized data:
determine a failure to locally generate, based on processing the user input using the machine learning model or another machine learning model locally at the client device, the natural language interpretation of the gesture of the user or another natural language interpretation of the gesture of the user,
wherein the instructions to generate the anonymized data are executed in response to determining the failure to locally generate the natural language interpretation of the gesture of the user or the other natural language interpretation of the gesture of the user.

16. The client device of claim 1, wherein the natural language interpretation of the gesture of the user indicates an English natural language interpretation of American Sign Language communicative input that is included in the user input.

17. The client device of claim 1, wherein the gesture of the user is a request for a search query to be performed, and performing the action includes performing at least one of the search query or another search query associated with the search query.

18. A system comprising:
memory storing instructions; and
one or more processors operable to execute the instructions, stored in the memory, to:
receive, from a client device, a subset of anonymized data that is indicative of a gesture of a user, and that is indicative of a device identifier associated with the subset of the anonymized data;
generate, based on processing the subset of the anonymized data using a machine learning model, a natural language interpretation of the gesture of the user; and
transmit, based on the device identifier associated with the subset of the anonymized data, the natural language interpretation to the client device or another client device.

19. The system of claim 18, wherein the data that is indicative of the gesture of the user is indicative of one or more of a hand gesture of the user and a facial gesture of the user.

20. A non-transitory computer-readable medium with a memory the includes instructions executable by one or more computers which, upon such execution, cause the one or more computers to:
receive user input that visually indicates a gesture of a user and a personal identity of the user;
generate, based on processing the user input using a machine learning model, anonymized data that indicates the gesture of the user and that anonymizes the personal identity of the user;
transmit a subset of the anonymized data to a computing device;
receive, at the client device and from the computing device, natural language interpretation data that corresponds to the anonymized data, and that identifies a natural language interpretation of the gesture of the user; and
perform an action based on the natural language interpretation of the gesture of the user.
